(19) United States
(12) Patent Application Publication
(10) Pub. No.: US 2011/0200926 A1
(43) Pub. Date: Aug. 18, 2011

(54) ELECTROPHOTOGRAPHIC PHOTOCONDUCTOR, IMAGE FORMING METHOD, IMAGE FORMING APPARATUS, AND PROCESS CARTRIDGE

(75) Inventors: Yuuji TANAKA, Shizuoka (JP); Norio Nagayama, Shizuoka (JP); Hiromi Sakaguchi, Kanagawa (JP); Tetsuro Suzuki, Shizuoka (JP); Kazukiyo Nagai, Shizuoka (JP)

(73) Assignee: RICOH COMPANY, LTD., Tokyo (JP)

(21) Appl. No.: 13/020,355

(22) Filed: Feb. 3, 2011

(30) Foreign Application Priority Data
Feb. 17, 2010 (JP) 2010-032086

(51) Int. Cl. G03G 5/04; G03G 13/20; G03G 15/02

(52) U.S. Cl. 430/58.05; 430/56; 430/124.1; 399/168

(57) ABSTRACT

An electrophotographic photoconductor including a layer comprising a cross-linked hardened material of a compound A with a compound B. Each of the compounds A and B has at least two alcohol groups, at least one of the compounds A and B has at least two methylol groups, at least one of the compounds A and B has at least three alcohol groups, and at least one of the compounds A and B has a charge transportable group. In other words, the compound A has X methylol groups, X being an integer of 2 or more, the compound B has Y alcohol groups, Y being an integer of 2 or more, at least one of the compounds A and B has a charge transportable group, and the following relations are satisfied:
x=2 and y≧3, or
x≧3 and y≧2.

### CROSS-REFERENCE TO RELATED APPLICATIONS

The present patent application claims priority pursuant to 35 U.S.C. §119 from Japanese Patent Application No. 2010-032086, filed on Feb. 17, 2010, which is hereby incorporated by reference herein in its entirety.

### BACKGROUND

1. Field of the Invention

The present invention relates to an electrophotographic photoconductor. In addition, the present invention also relates to an image forming method, an image forming apparatus, and a process cartridge using the electrophotographic photoconductor.

2. Description of the Background

Organic photoconductors (hereinafter “OPC”) are widely used in image forming apparatuses such as copiers, facsimile machines, laser printers, etc., in place of inorganic photoconductors recently. Organic photoconductors have various advantages over inorganic photoconductors. For example, organic photoconductors:
(1) have better optical properties (e.g., wider wavelength range and greater absorption amount in optical absorption);
(2) have better electric properties (e.g., higher sensitivity, more stable charge);
(3) are more flexible in selecting materials;
(4) are more easily manufacturable;
(5) cost much less; and
(6) are nontoxic.

Photoconductors are needed to be more compact, in other words, to have a much smaller diameter, in accordance with recent trend to favor compact image forming apparatus. Photoconductors are also needed to be more durable to be usable in recent high-speed and maintenance-free image forming apparatuses. On the other hand, organic photoconductors are easily abradable when repeatedly exposed to mechanical stresses in electrophotographic imaging processes, because the organic photoconductors generally have a soft charge transport layer comprised of a low-molecular-weight charge transport material and an inactive polymer.

Toners are needed to be much smaller to meet demand for higher image quality. When such small toner particles undesirably remain on a photoconductor and are removed with a blade, the blade needs to have a high rubber hardness and to contact the photoconductor with a high pressure, resulting in abrasion of the photoconductor. The photoconductor degrades its sensitivity and electric properties by the abrasion, and thus produces abnormal images with low image density and background fouling. When scratches are locally made on the photoconductor by the abrasion, residual toner particles on the photoconductor may be insufficiently removed, resulting in an image having linear fouling.

Various attempts have been made to improve abrasion resistance of OPC. For example:
(1) Japanese Patent Application Publication No. (hereinafter “JP-A”) S56-48637 describes a charge transport layer comprised of a hardenable binder;
(2) JP-S64-1728-A describes the use of a polymeric charge transport material;
(3) JP-H04-281461-A describes a charge transport layer dispersing an inorganic filler;
(4) Japanese Patent No. 3262488 describes the use of a cured compound of a polyfunctional acrylate monomer;
(5) Japanese Patent No. 3194392 describes a charge transport layer formed from a coating liquid comprising a monomer having C—C double bond, a charge transport material having C—C double bond, and a binder resin;
(6) JP-2000-66425-A describes the use of a cured compound of a hole transport compound having at least two chain-polymerizable functional groups per molecule;
(7) JP-H06-118681-A describes the use of a hardenable silicone resin including a colloidal silica;
(8) JP-H09-124943-A describes a resin layer formed by binding an organic silicon-modified hole transport compound to a hardenable organic silicon polymer;
(9) JP-H09-190004-A also describes a resin layer formed by binding an organic silicon-modified hole transport compound to a hardenable organic silicon polymer;
(10) JP-2000-171990-A describes the use of a three-dimensionally-networked cured compound of a hardenable siloxane resin having a charge transport group;
(11) JP-2003-186223-A describes the use of a combination of a charge transport material having at least one hydroxyl group, a three-dimensionally-cross-linked resin, and a conductive particle;
(12) JP-2007-293197-A describes the use of a cross-linked resin of a polyol having at least two hydroxyl groups and at least a reactive charge transport material, with an aromatic isocyanate compound;
(13) JP-2008-299327-A describes the use of a melamine formaldehyde resin three-dimensionally-cross-linked with a charge transport material having at least one hydroxyl group; and
(14) Japanese Patent No. 4262061 describes the use of a resol-type phenol resin three-dimensionally-cross-linked with a charge transport material having a hydroxyl group.

When a surface layer of an electrophotographic photoconductor is comprised of a thermoplastic resin dispersing a low-molecular-weight charge transport material, free external additives released from toner particles, such as fine silica particles having a high hardness, may easily get stuck therein because the surface layer is generally softer than silica. The surface layer needs to be much harder to solve this problem. A harder surface layer can be obtained by, for example, cross-linking a polyfunctional monomer, but cannot be obtained by only replacing the low-molecular-weight charge transport material with a high-molecular-weight charge transport resin.

The cross-linked layer of the polyfunctional monomer further needs to include a charge transport material to exert proper electric properties as an electrophotographic photoconductor. There have been various attempts to include a charge transport material in a cross-linked layer. For example, there is an attempt to harden an alkoxysilane while adding a charge transport material thereto. In many cases, the charge transport material is found to have poor compatibility with the alkoxysilane, but this problem can be solved by using a charge transport material having hydroxyl groups having better compatibility with the alkoxysilane. But the charge transport material having hydroxyl groups requires a heater to avoid blurring of images under high-humidity and high-temperature conditions in case the unreacted hydroxyl groups remain.

There is another attempt to harden a resin having a high-polarity unit, such as a urethane resin, while adding a charge transport material having hydroxyl groups thereto. This attempt results in poor charge mobility due to low dielectric constant, and increase of residual potential.

There is yet another attempt to harden a phenol resin while adding a charge transport material having hydroxyl groups thereto. This attempt results in deterioration of electric properties due to the presence of phenolic hydroxyl groups. Such deterioration of electric properties can be avoided by controlling the amount of the phenolic hydroxyl groups or replacing the phenolic hydroxyl groups with other functional groups. In the latter case, the phenol resin can become more hydrophobic-resin-wettable, but it is not easy to form a reliable layer when the solvent which poorly dissolves the hydrophobic resin is used.

### SUMMARY

Exemplary aspects of the present invention are put forward in view of the above-described circumstances, and provide a novel electrophotographic photoconductor having high abrasion resistance and high durability which produces high quality images for an extended period of time.

In one exemplary embodiment, a novel electrophotographic photoconductor includes a layer comprising a cross-linked hardened material of a compound A with a compound B. Each of the compounds A and B has at least two alcohol groups, at least one of the compounds A and B has at least two methylol groups, at least one of the compounds A and B has at least three alcohol groups, and at least one of the compounds A and B has a charge transportable group. In other words, the compound A has X methylol groups, X being an integer of 2 or more, the compound B has Y alcohol groups, Y being an integer of 2 or more, at least one of the compounds A and B has a charge transportable group, and the following relations are satisfied:
x=2 and y≧3, or
x≧3 and y≧2.

In another exemplary embodiment, a novel image forming method includes charging a surface of the above-described electrophotographic photoconductor; irradiating the charged surface of the electrophotographic photoconductor with light to form an electrostatic latent image thereon; developing the electrostatic latent image into a toner image; transferring the toner image from the electrophotographic photoconductor onto a recording medium; and fixing the toner image on the recording medium.

In yet another exemplary embodiment, a novel image forming apparatus includes the above-described electrophotographic photoconductor; a charger that charges a surface of the electrophotographic photoconductor; an irradiator that irradiates the charged surface of the electrophotographic photoconductor with light to form an electrostatic latent image thereon; a developing device that develops the electrostatic latent image into a toner image; a transfer device that transfers the toner image from the electrophotographic photoconductor onto a recording medium; and a fixing device that fixes the toner image on the recording medium.

In yet another exemplary embodiment, a novel process cartridge detachably mountable on image forming apparatus includes the above-described electrophotographic photoconductor; and at least one of a charger, an irradiator, a developing device, a cleaning device, and a decharging device.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIGS. 1 to 15 illustrate infrared absorption spectra of the compounds synthesized in Synthesis Examples 1 to 15, respectively, each obtained by a KBr tablet method;

FIG. 16 is a schematic view illustrating an image forming apparatus according to exemplary aspects of the invention;

FIG. 17 is a schematic view illustrating another image forming apparatus according to exemplary aspects of the invention; and

FIG. 18 is a schematic view illustrating a process cartridge according to exemplary aspects of the invention.

### DETAILED DESCRIPTION

Exemplary aspects of the present invention provide an electrophotographic photoconductor, an image forming method, an image forming apparatus, and a process cartridge.

The electrophotographic photoconductor according to exemplary aspects of the invention includes a layer comprising a cross-linked hardened material of a compound A with a compound B. Each of the compounds A and B has at least two alcohol groups, at least one of the compounds A and B has at least two methylol groups, at least one of the compounds A and B has at least three alcohol groups, and at least one of the compounds A and B has a charge transportable group.

The electrophotographic photoconductor according to exemplary aspects of the invention prevents free external additives released from toner particles, such as fine silica particles having a high hardness, from getting stuck therein, while maintaining high abrasion resistance and electric properties. Thus, the electrophotographic photoconductor is unlikely to produce defective image with white spots.

The electrophotographic photoconductor according to exemplary aspects of the invention, which is obtained from a hardening reaction between alcoholic hydroxyl groups and highly-reactive methylol groups, has excellent charge transportability, because the alcoholic hydroxyl groups do not adversely affect electric properties. The hardening or cross-linking reaction can be accelerated by using a hardening catalyst, such as a hardening accelerator or a polymerization initiator, while applying heat.

The electrophotographic photoconductor according to exemplary aspects of the invention can be more hydrophobic-resin-wettable because of being comprised of only low-molecular-weight materials.

A triphenylamine compound having methylol groups are capable of cross-linking by using a slight amount of a hardening catalyst. A condensation reaction between a methylol group and another methylol or alcohol group produces an ether bond or a methylene bond. Alternatively, a condensation reaction between a methylol group and a hydrogen atom in a benzene group in the triphenylamine compound produces a methylene bond. A highly-cross-linked three-dimensional hardened layer is formed by the occurrence of these condensation reactions.

Such a cross-linked layer has good electric property, hydrophobic-resin-wettability, and a very high cross-linking density. The layer prevents silica particles from getting stuck therein, thus preventing production of defective image with white spots. The cross-linked layer preferably includes gel in an amount of 95% or more, and more preferably 97% or more, so as to more improve abrasion resistance.

Again, the electrophotographic photoconductor according to exemplary aspects of the invention includes a layer comprising a cross-linked hardened material of a compound A with a compound B. Each of the compounds A and B has at least two alcohol groups, at least one of the compounds A and B has at least two methylol groups, at least one of the compounds A and B has at least three alcohol groups, and at least one of the compounds A and B has a charge transportable group.

In one embodiment, the compound A may be, for example, a compound having at least two methylol groups having the following formula:

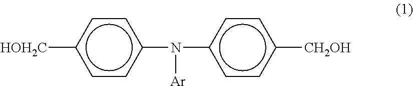

wherein Ar represents an aryl group which may have a substituent;

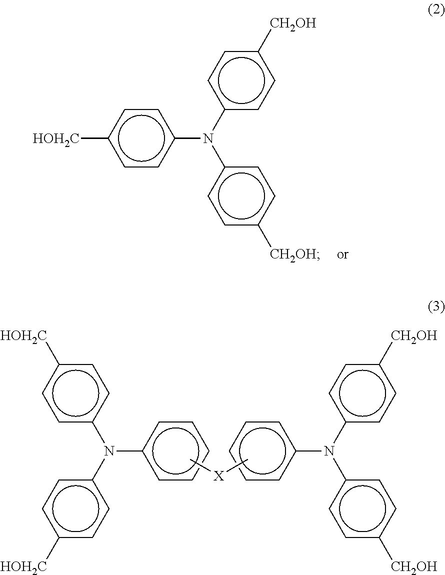

wherein X represents —O—, —CH₂—, —CH═CH—, or —CH₂CH₂—.

In this embodiment, the compound B has at least two alcohol groups, and at least one of the compounds A and B is tri- or more-functional and charge-transportable.

Specific examples of the methylol compounds having the formula (1) are shown in Table 1, but are not limited thereto.

TABLE 1

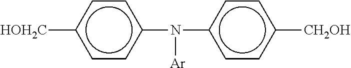

| Compound No. | Ar |
|---|---|
| 1 | 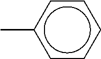 |
| 2 | 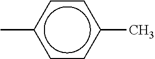 |
| 3 | 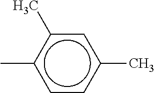 |
| 4 | 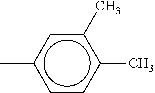 |

The methylol compound having the formula (2) may be hereinafter referred to as a compound No. 5.

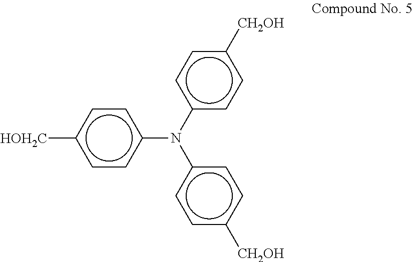

Specific examples of the methylol compounds having the formula (3) are shown in Table 2, but are not limited thereto.

TABLE 2

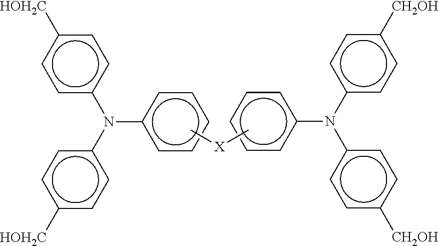

| Compound No. | 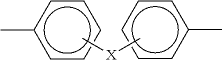 |
|---|---|
| 6 | 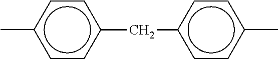 |
| 7 | 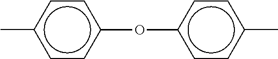 |
| 8 | 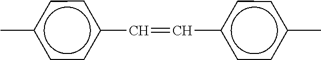 |
| 9 | 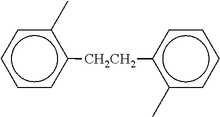 |
| 10 | 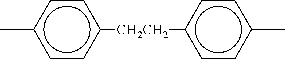 |
| 11 | 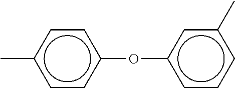 |

The methylol compounds having the formula (1), (2), or (3) can be obtained by, for example, synthesizing an aldehyde compound and reacting the aldehyde compound with a reductant such as sodium borohydride.

For example, an aldehyde compound can be synthesized by formylation (e.g., the Vilsmeier reaction) of a triphenylamine compound, as follows. An exemplary formylation procedure is described in Japanese Patent No. 3943522, the disclosure thereof being incorporated herein by reference.

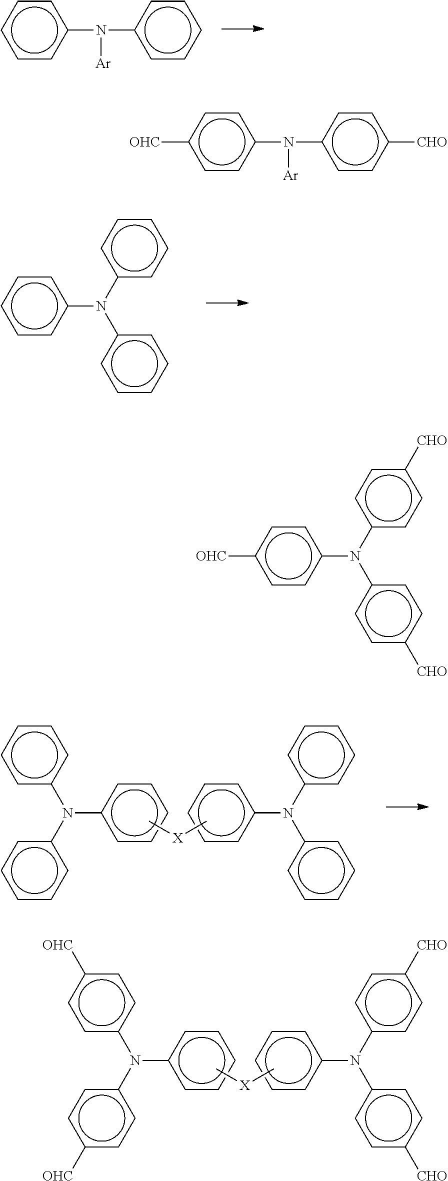

Preferably, the formylation is performed using zinc chloride, phosphorous oxychloride, and dimethyl formaldehyde.

Subsequently, the aldehyde compound is reduced to obtain a methylol compound, as follows.

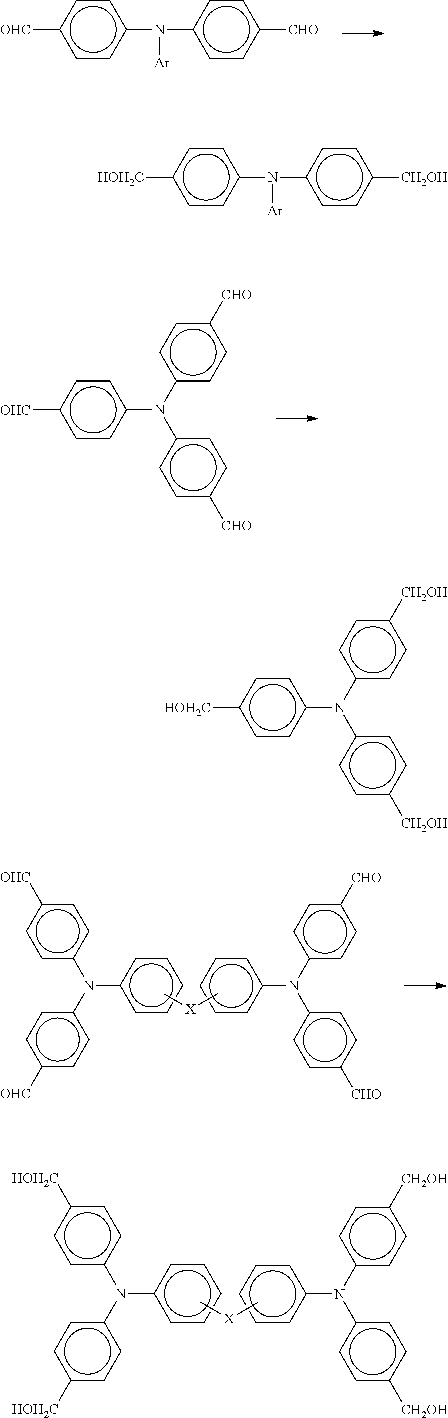

Preferably, the reduction is performed using phosphorous oxychloride.

In the reaction between the compounds A and B, the alcoholic hydroxyl groups, which do not adversely affect electric properties, cross-link with the methylol groups having high reactivity, resulting in a highly-cross-linked layer having excellent charge transportability. The layer advantageously has abrasion resistance, mechanical durability, and heat resistance, as well as excellent charge transportability. The layer may be applicable not only to OPC but also to organic functional materials for use in organic semiconductor devices such as organic EL, organic TFT, and organic solar battery.

Specific examples of the compound having at least two methylol groups further include, but are not limited to, p-xylylene glycol, m-xylylene glycol, o-xylylene glycol, and the compound having the following formula (4):

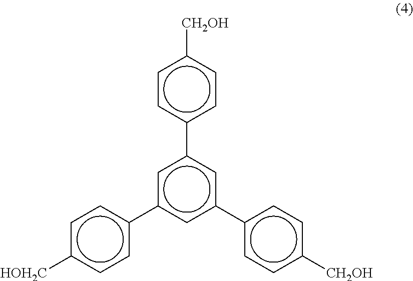

In this specification, an alcohol group is defined as a hydrocarbon group to which at least one hydroxyl group binds. Specific examples of the alcohol group include methylol group, ethyl alcohol group, and butyl alcohol group, but are not limited thereto.

Specific examples of the compound having at least two alcohol groups include, but are not limited to, ethylene glycol, polyethylene glycol, 1,2,4-butanetriol, 1,2,3-butanetriol, trimethylolpropane, 1,2,5-pentantriol, glycerol, erythritol, pentaerythritol, the compounds having the following formulae (5) to (8), and polyvinyl butyral:

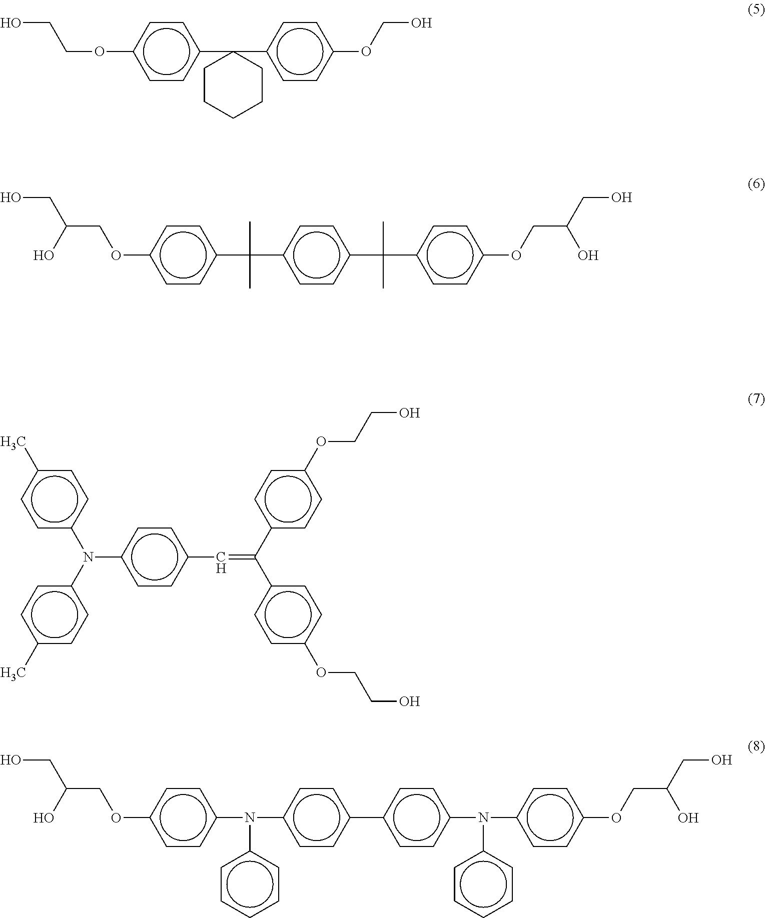

Further understanding can be obtained by reference to certain specific examples which are provided herein for the purpose of illustration only and are not intended to be limiting. In the descriptions in the following examples, the numbers represent weight ratios in parts, unless otherwise specified.

### SYNTHESIS EXAMPLE 1

### Synthesis of Compound No. 1

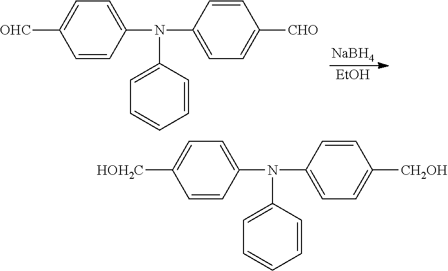

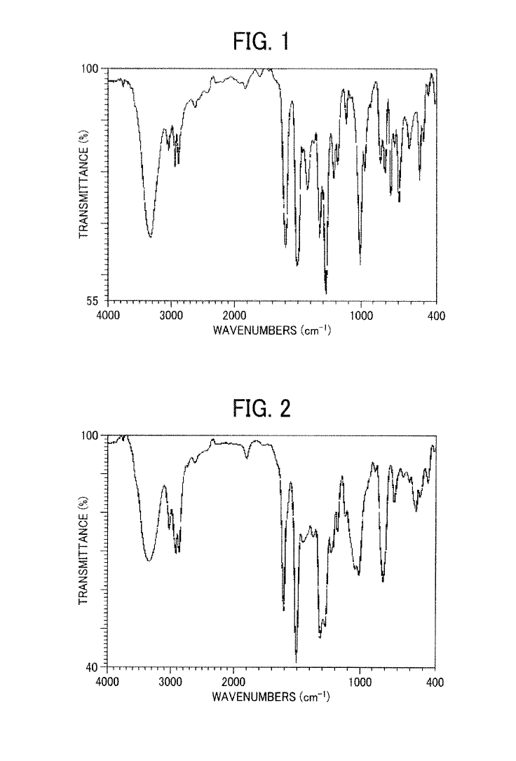

A four-necked flask is charged with 3.01 g of an intermediate aldehyde compound and 50 ml of ethanol, and the mixture is agitated at room temperature. Further, 1.82 g of sodium borohydride is added to the flask, and the mixture is kept agitated for 6 hours. The mixture is then subjected to extraction with ethyl acetate, dehydration with magnesium sulfate, and adsorption with activated white earth and silica gel, followed by filtration, washing, and condensation, thus obtaining a crystal. The crystal is dispersed in n-hexane and further subjected to filtration, washing, and drying. Thus, 2.86 g of a white crystal of the Compound No. 1 is obtained. An infrared absorption spectrum of the Compound No. 1 is shown in FIG. 1.

### SYNTHESIS EXAMPLE 2

### Synthesis of Compound No. 3

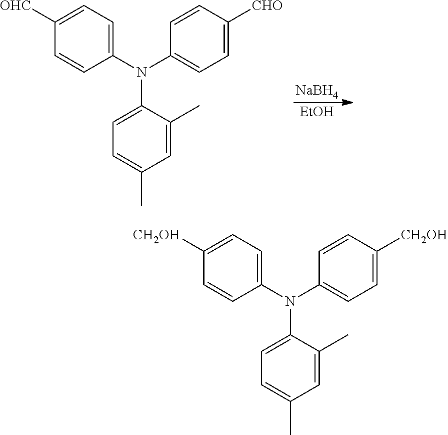

A four-necked flask is charged with 3.29 g of an intermediate aldehyde compound and 50 ml of ethanol, and the mixture is agitated at room temperature. Further, 1.82 g of sodium borohydride is added to the flask, and the mixture is kept agitated for 5 hours. The mixture is then subjected to extraction with ethyl acetate, dehydration with magnesium sulfate, and adsorption with activated white earth and silica gel, followed by filtration, washing, and condensation, thus obtaining an amorphous. The amorphous is dispersed in n-hexane and further subjected to filtration, washing, and drying. Thus, 3.03 g of a white amorphous of the Compound No. 3 is obtained. An infrared absorption spectrum of the Compound No. 3 is shown in FIG. 2.

### SYNTHESIS EXAMPLE 3

### Synthesis of Compound No. 5

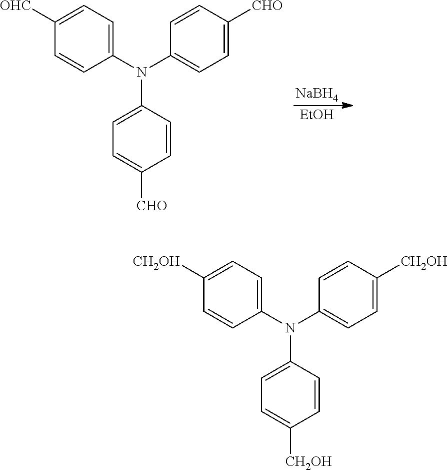

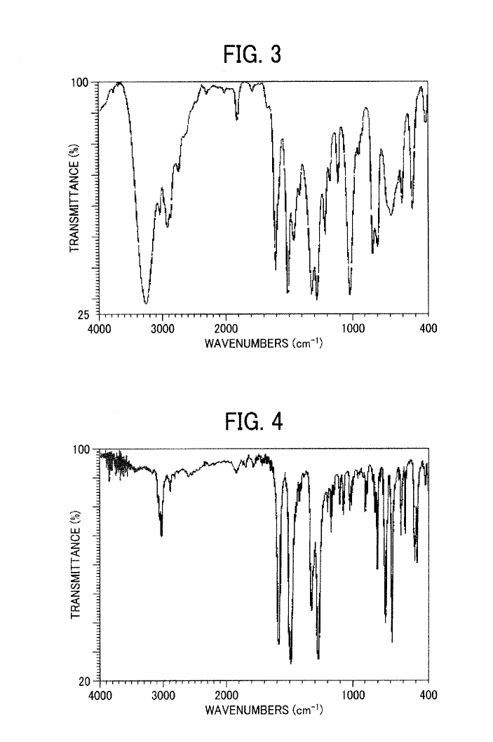

A four-necked flask is charged with 3.29 g of an intermediate aldehyde compound and 50 ml of ethanol, and the mixture is agitated at room temperature. Further, 1.82 g of sodium borohydride is added to the flask, and the mixture is kept agitated for 12 hours. The mixture is then subjected to extraction with ethyl acetate, dehydration with magnesium sulfate, and adsorption with activated white earth and silica gel, followed by filtration, washing, and condensation, thus obtaining a crystal. The crystal is dispersed in n-hexane and further subjected to filtration, washing, and drying. Thus, 2.78 g of a white crystal of the Compound No. 5 is obtained. An infrared absorption spectrum of the Compound No. 5 is shown in FIG. 3.

### SYNTHESIS EXAMPLE 4

### Synthesis of Intermediate Aldehyde Compound for Compound No. 6

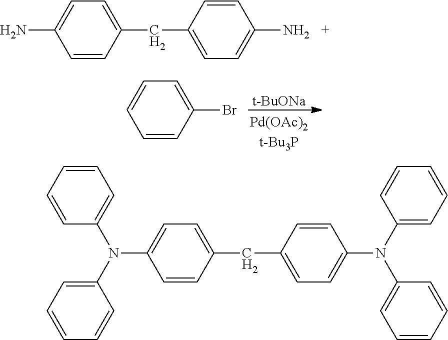

A four-necked flask is charged with 19.83 g of 4,4′-diaminodiphenylmethane, 69.08 g of bromobenzene, 2.24 g of palladium acetate, 46.13 g of tertiary-butoxy sodium, and 250 ml of o-xylene, and the mixture is agitated at room temperature under argon gas atmosphere. After dropping 8.09 g of tri-tertiary-butyl phosphine therein, the mixture is kept agitated for 1 hour at 80° C. and another 1 hour during reflux. The mixture is then diluted with toluene, mixed with magnesium sulfate, activated white earth, and silica gel, and subjected to filtration, washing, and condensation, thus obtaining a crystal. The crystal is dispersed in methanol and further subjected to filtration, washing, and drying. Thus, 45.73 g of a pale yellow powder of an intermediate aldehyde compound (1) for the Compound No. 6 is obtained. An infrared absorption spectrum of the intermediate aldehyde compound (1) is shown in FIG. 4.

### SYNTHESIS EXAMPLE 5

### Synthesis of Intermediate Aldehyde Compound for Compound No. 6

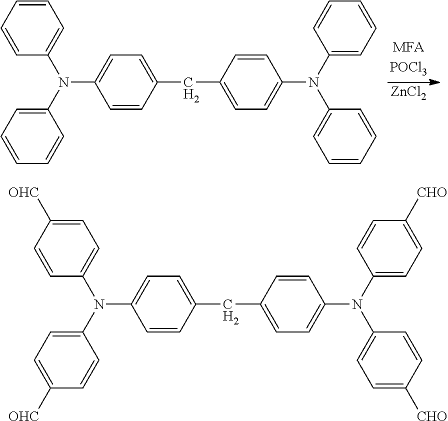

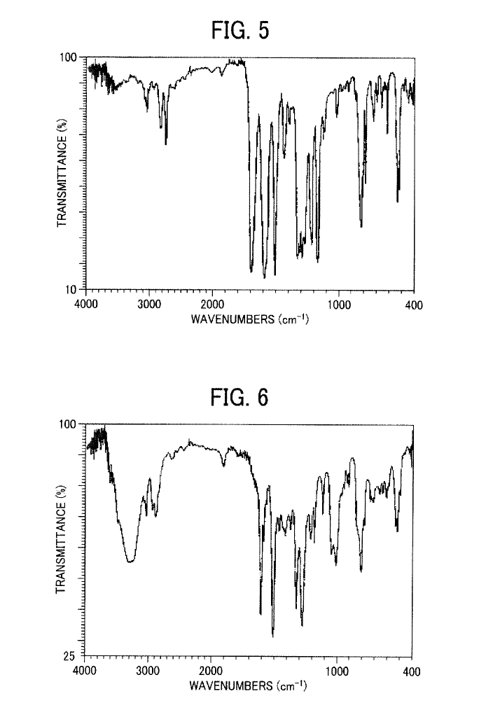

A four-necked flask is charged with 30.16 g of the intermediate aldehyde compound (1), 71.36 g of N-methyl formanilide, and 400 ml of o-dichlorobenzene, and the mixture is agitated at room temperature under argon gas atmosphere. After dropping 82.01 g of phosphorous oxychloride therein, the mixture is heated to 80° C. and kept agitated. After dropping 32.71 g of zinc chloride therein, the mixture is kept agitated for about 10 hours at 80° C. and about 3 hours at 120° C. Thereafter, an aqueous solution of potassium hydroxide is added thereto to undergo hydrolysis reaction. The mixture is then subjected to extraction with dichloromethane, dehydration with magnesium sulfate, and adsorption with activated white earth, followed by filtration, washing, and condensation, thus obtaining a crystal. The crystal is purified with a silica gel column with a mixed solvent of toluene/ethyl acetate (8/2), and recrystallized with a mixed solvent of methanol/ethyl acetate. Thus, 27.80 g of a yellow powder of an intermediate aldehyde compound (2) for the Compound No. 6 is obtained. An infrared absorption spectrum of the intermediate aldehyde compound (2) is shown in FIG. 5.

### SYNTHESIS EXAMPLE 6

### Synthesis of Compound No. 6

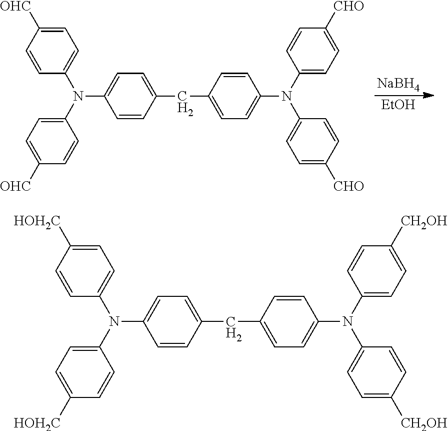

A four-necked flask is charged with 12.30 g of the intermediate aldehyde compound (2) and 150 ml of ethanol, and the mixture is agitated at room temperature. Further, 3.63 g of sodium borohydride is added to the flask, and the mixture is kept agitated for 4 hours. The mixture is then subjected to extraction with ethyl acetate, dehydration with magnesium sulfate, and adsorption with activated white earth and silica gel, followed by filtration, washing, and condensation, thus obtaining an amorphous. The amorphous is dispersed in n-hexane and further subjected to filtration, washing, and drying. Thus, 12.0 g of a pale yellowish-white amorphous of the Compound No. 6 is obtained. An infrared absorption spectrum of the Compound No. 6 is shown in FIG. 6.

### SYNTHESIS EXAMPLE 7

### Synthesis of Intermediate Aldehyde Compound for Compound No. 7

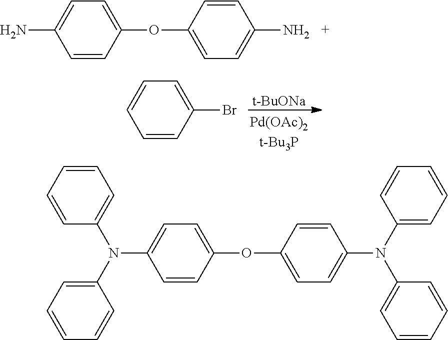

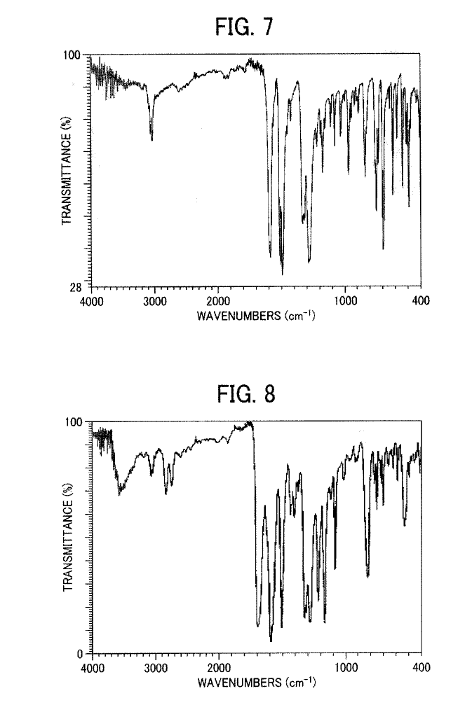

A four-necked flask is charged with 20.02 g of 4,4′-diaminodiphenyl ether, 69.08 g of bromobenzene, 0.56 g of palladium acetate, 46.13 g of tertiary-butoxy sodium, and 250 ml of o-xylene, and the mixture is agitated at room temperature under argon gas atmosphere. After dropping 2.02 g of tri-tertiary-butyl phosphine therein, the mixture is kept agitated for 1 hour at 80° C. and another 1 hour during reflux. The mixture is then diluted with toluene, mixed with magnesium sulfate, activated white earth, and silica gel, and subjected to filtration, washing, and condensation, thus obtaining a crystal. The crystal is dispersed in methanol and further subjected to filtration, washing, and drying. Thus, 43.13 g of a pale brown powder of an intermediate aldehyde compound (3) for the Compound No. 7 is obtained. An infrared absorption spectrum of the intermediate aldehyde compound (3) is shown in FIG. 7.

### SYNTHESIS EXAMPLE 8

### Synthesis of Intermediate Aldehyde Compound for Compound No. 7

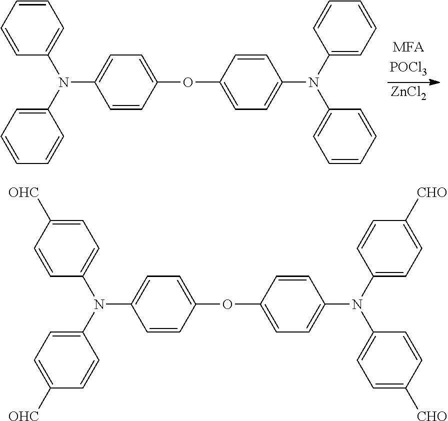

A four-necked flask is charged with 30.27 g of the intermediate aldehyde compound (3), 71.36 g of N-methyl formanilide, and 300 ml of o-dichlorobenzene, and the mixture is agitated at room temperature under argon gas atmosphere. After dropping 82.01 g of phosphorous oxychloride therein, the mixture is heated to 80° C. and kept agitated. After dropping 16.36 g of zinc chloride therein, the mixture is kept agitated for 1 hour at 80° C., 4 hours at 120° C., and 3 hours at 140° C. Thereafter, an aqueous solution of potassium hydroxide is added thereto to undergo hydrolysis reaction. The mixture is then extracted with toluene and mixed with magnesium sulfate, followed by filtration, washing, and condensation. The mixture is further subjected to column purification with a mixed solvent of toluene/ethyl acetate, followed by condensation, thus obtaining a crystal. The crystal is dispersed in methanol and further subjected to filtration, washing, and drying. Thus, 14.17 g of a pale yellow powder of an intermediate aldehyde compound (4) for the Compound No. 7 is obtained. An infrared absorption spectrum of the intermediate aldehyde compound (4) is shown in FIG. 8.

### SYNTHESIS EXAMPLE 9

### Synthesis of Compound No. 7

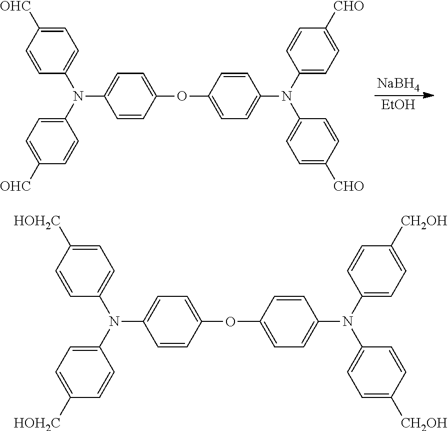

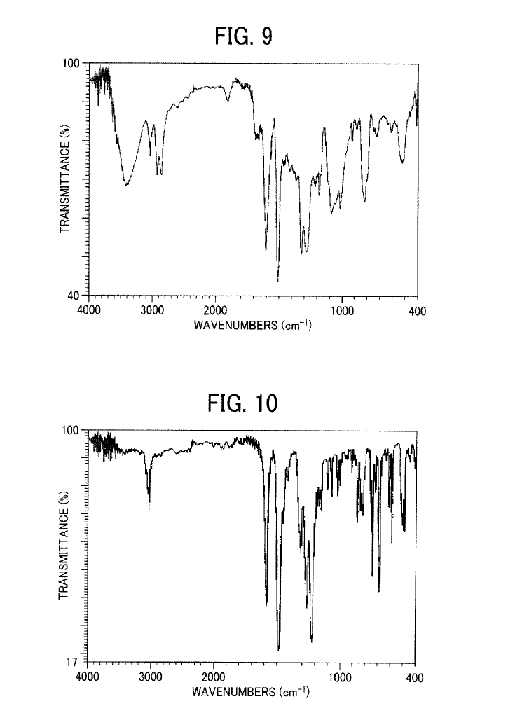

A four-necked flask is charged with 6.14 g of the intermediate aldehyde compound (4) and 75 ml of ethanol, and the mixture is agitated at room temperature. Further, 1.82 g of sodium borohydride is added to the flask, and the mixture is kept agitated for 7 hours. The mixture is then subjected to extraction with ethyl acetate, dehydration with magnesium sulfate, and adsorption with activated white earth and silica gel, followed by filtration, washing, and condensation, thus obtaining an amorphous. The amorphous is dispersed in n-hexane and further subjected to filtration, washing, and drying. Thus, 5.25 g of a white amorphous of the Compound No. 7 is obtained. An infrared absorption spectrum of the Compound No. 7 is shown in FIG. 9.

### SYNTHESIS EXAMPLE 10

### Synthesis of Intermediate Aldehyde Compound for Compound No. 8

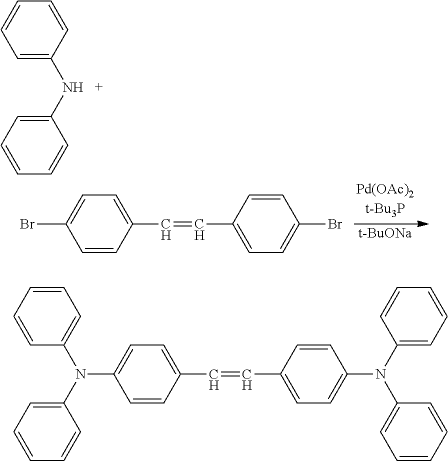

A four-necked flask is charged with 22.33 g of diphenylamine, 20.28 g of dibromostilbene, 0.336 g of palladium acetate, 13.84 g of tertiary-butoxy sodium, and 150 ml of o-xylene, and the mixture is agitated at room temperature under argon gas atmosphere. After dropping 1.22 g of tri-tertiary-butyl phosphine therein, the mixture is kept agitated for 1 hour at 80° C. and 2 hours during reflux. The mixture is then diluted with toluene, mixed with magnesium sulfate, activated white earth, and silica gel, and subjected to filtration, washing, and condensation, thus obtaining a crystal. The crystal is dispersed in methanol and further subjected to filtration, washing, and drying. Thus, 29.7 g of a yellow powder of an intermediate aldehyde compound (5) for the Compound No. 8 is obtained. An infrared absorption spectrum of the intermediate aldehyde compound (5) is shown in FIG. 10.

### SYNTHESIS EXAMPLE 11

### Synthesis of Intermediate Aldehyde Compound for Compound No. 8

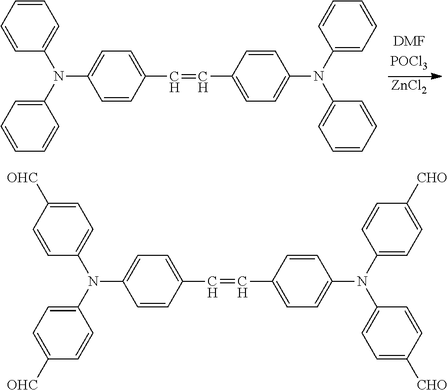

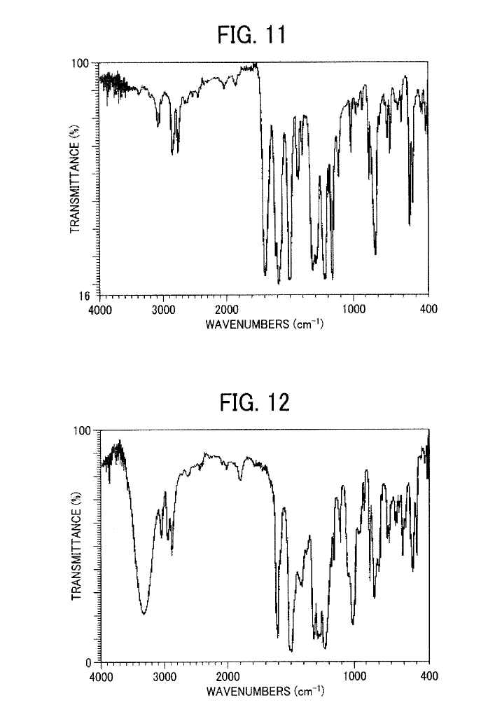

A four-necked flask is charged with 33.44 g of dehydrated dimethyl formaldehyde and 84.53 g of dehydrated toluene, and the mixture is agitated in ice water bath under argon gas atmosphere. After dropping 63.8 g of phosphorous oxychloride therein, the mixture is kept agitated for about 1 hour. After dropping 26.76 g of the intermediate aldehyde compound (5) and 106 g of dehydrated toluene therein, the mixture is agitated for 1 hour at 80° C. and 5 hours during reflux. Thereafter, an aqueous solution of potassium hydroxide is added thereto to undergo hydrolysis reaction. The mixture is then extracted with toluene and dehydrated with magnesium sulfate, followed by condensation. The mixture is further subjected to column purification with a mixed solvent of toluene/ethyl acetate (8/2), followed by condensation. The product is dispersed in methanol and further subjected to filtration, washing, and drying. Thus, 16.66 g of an orange powder of an intermediate aldehyde compound (6) for the Compound No. 8 is obtained. An infrared absorption spectrum of the intermediate aldehyde compound (6) is shown in FIG. 11.

### SYNTHESIS EXAMPLE 12

### Synthesis of Compound No. 8

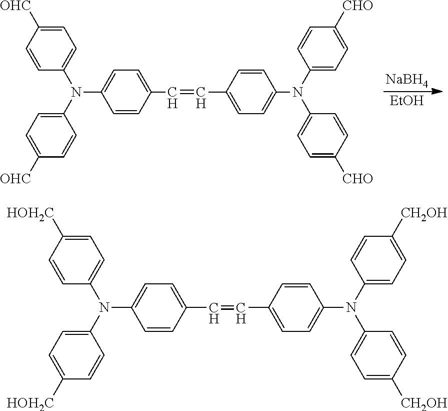

A four-necked flask is charged with 6.54 g of the intermediate aldehyde compound (6) and 75 ml of ethanol, and the mixture is agitated at room temperature. Further, 1.82 g of sodium borohydride is added to the flask, and the mixture is kept agitated for 4 hours. The mixture is then subjected to extraction with ethyl acetate, dehydration with magnesium sulfate, and adsorption with activated white earth and silica gel, followed by filtration, washing, and condensation, thus obtaining an amorphous. The amorphous is dispersed in n-hexane and further subjected to filtration, washing, and drying. Thus, 2.30 g of a yellow amorphous of the Compound No. 8 is obtained. An infrared absorption spectrum of the Compound No. 8 is shown in FIG. 12.

### SYNTHESIS EXAMPLE 13

### Synthesis of Intermediate Aldehyde Compound for Compound No. 9

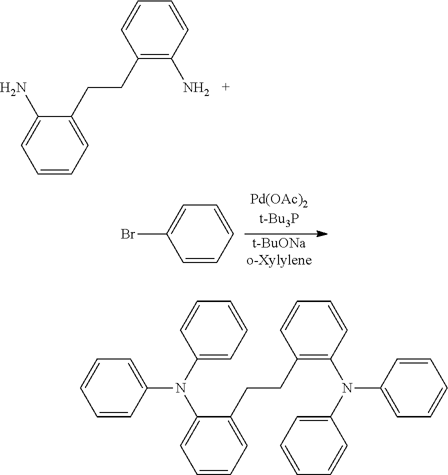

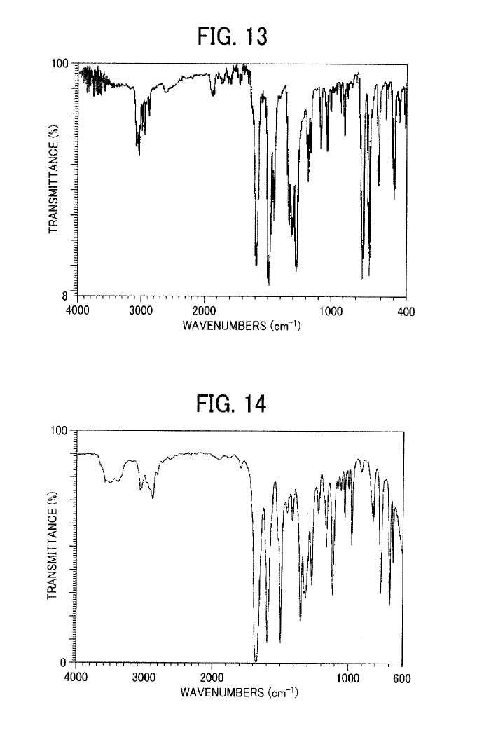

A four-necked flask is charged with 21.33 g of 2,2′-ethylene dianiline, 75.36 g of bromobenzene, 0.56 g of palladium acetate, 46.13 g of tertiary-butoxy sodium, and 250 ml of o-xylene, and the mixture is agitated at room temperature under argon gas atmosphere. After dropping 2.03 g of tri-tertiary-butyl phosphine therein, the mixture is kept agitated for 8 hours during reflux. The mixture is then diluted with toluene, mixed with magnesium sulfate, activated white earth, and silica gel at room temperature, and subjected to filtration, washing, and condensation, thus obtaining a crystal. The crystal is dispersed in methanol and further subjected to filtration, washing, and drying. Thus, 47.65 g of a pale brown powder of an intermediate aldehyde compound (7) for the Compound No. 9 is obtained. An infrared absorption spectrum of the intermediate aldehyde compound (7) is shown in FIG. 13.

### SYNTHESIS EXAMPLE 14

### Synthesis of Intermediate Aldehyde Compound for Compound No. 9

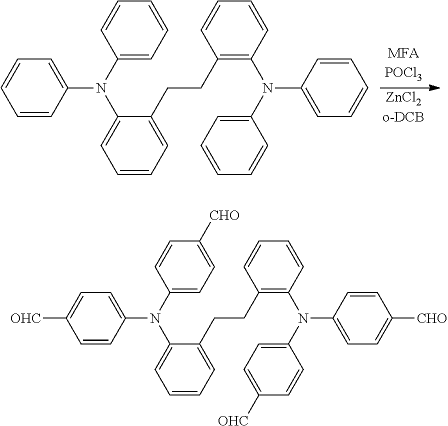

A four-necked flask is charged with 31.0 g of the intermediate aldehyde compound (7), 71.36 g of N-methyl formanilide, and 400 ml of o-dichlorobenzene, and the mixture is agitated at room temperature under argon gas atmosphere. After dropping 82.01 g of phosphorous oxychloride therein, the mixture is heated to 80° C. After dropping 32.71 g of zinc chloride therein, the mixture is kept agitated for 1 hour at 80° C. and about 24 hours at 120° C. Thereafter, an aqueous solution of potassium hydroxide is added thereto to undergo hydrolysis reaction. The mixture is then diluted with toluene and washed with water. The oil phase is dehydrated with magnesium chloride and adsorbed with activated white earth and silica gel, followed by filtration, washing, and condensation. Thus, 22.33 g of a yellow liquid of an intermediate aldehyde compound (8) for the Compound No. 9 is obtained. An infrared absorption spectrum of the intermediate aldehyde compound (8) is shown in FIG. 14.

### SYNTHESIS EXAMPLE 15

### Synthesis of Compound No. 9

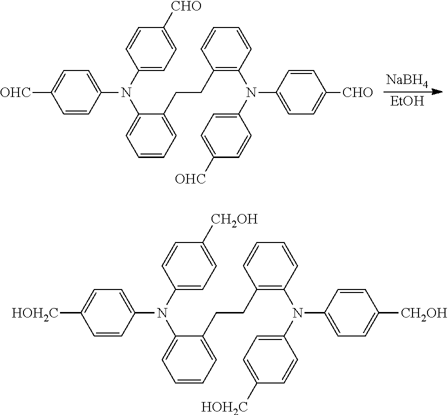

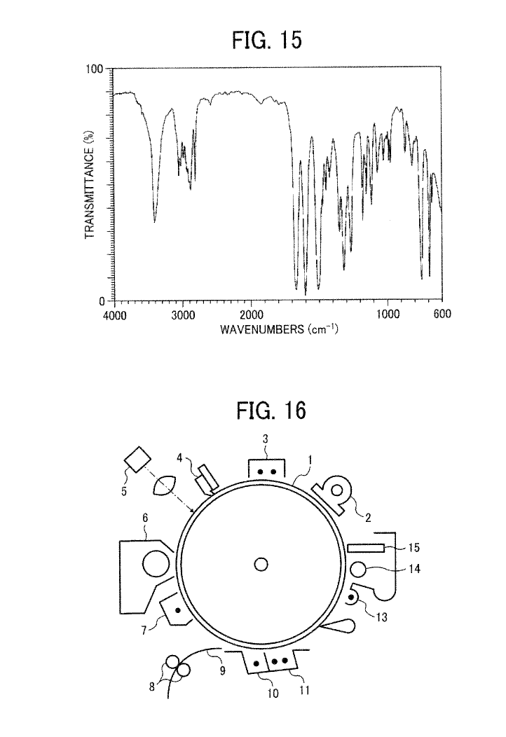

A four-necked flask is charged with 9.43 g of the intermediate aldehyde compound (8) and 100 ml of ethanol, and the mixture is agitated at room temperature. Further, 2.72 g of sodium borohydride is added to the flask, and the mixture is kept agitated for 7 hours. The mixture is then subjected to extraction with ethyl acetate, dehydration with magnesium sulfate, and adsorption with activated white earth and silica gel, followed by filtration, washing, and condensation, thus obtaining an amorphous. The amorphous is dispersed in n-hexane and further subjected to filtration, washing, and drying. Thus, 8.53 g of a white amorphous of the Compound No. 9 is obtained. An infrared absorption spectrum of the Compound No. 9 is shown in FIG. 15.

As shown above, exemplary methylol compounds, such as the Compounds No. 1 to 11, can be easily obtained by reducing intermediate aldehyde compounds.

The layer including hardened material of the compounds A with B can be formed by applying a coating liquid including the compounds A and B to the surface of a photosensitive layer and dried by heat.

When the monomers (i.e., the compounds A and B) are liquid, the coating liquid may be a solution of other compositions in the monomers. When the monomers are not liquid or the coating liquid needs dilution, the coating liquid may include a solvent.

Specific examples of usable solvents include, but are not limited to, alcohols (e.g., methanol, ethanol, propanol, butanol), ketones (e.g., acetone, methyl ethyl ketone, methyl isobutyl ketone, cyclohexanone), esters (e.g., ethyl acetate, butyl acetate), ethers (e.g., tetrahydrofuran, dioxane, propyl ether), halogen-containing solvents (e.g., dichloromethane, dichloroethane, trichloroethane, chlorobenzene), aromatic solvents (e.g., benzene, toluene, xylene), and cellosolves (e.g., methyl cellosolve, ethyl cellosolve, cellosolve acetate). Two or more of these solvents can be used in combination. The degree of dilution depends on solubility of the compositions, coating method employed, and/or a targeted thickness. Available coating methods include spray coating, bead coating, and ring coating, but are not limited thereto.

The coating liquid may further include additives, such as a plasticizer for improving stress relaxation and adhesiveness, a leveling agent, and a nonreactive low-molecular-weight charge transport material. Specific examples of usable leveling agents include, but are not limited to, silicone oils (e.g., dimethyl silicone oil, methyl phenyl silicone oil) and polymers and oligomers having a side chain having a perfluoroalkyl group. The content of the additives in the coating layer is preferably 3% by weight or less based on solid components.

The coated liquid is dried by heat to cause hardening reaction. The rate of gel in the resulting hardened material is preferably 95% or more, and more preferably 97% or more. The more the rate of gel, the more unlikely that silica gets stuck in the layer. The rate of gel can be determined by the following equation:

Rate of gel (%)=100×(W2/W1)

wherein W1 represents the initial weight of the hardened material and W2 represents the weight of the hardened material after dipped in a highly-soluble organic solvent (e.g., tetrahydrofuran) for 5 days.

Preferably, the layer including the hardened material forms the outermost layer of the electric photoconductor according to exemplary aspects of the invention. This is because the compounds having the formula (1), (2), or (3) have hole transportability, which are preferably present at the surface of a negatively-chargeable OPC.

An exemplary negatively-chargeable organic photoconductor includes, from an innermost side thereof, a substrate, an undercoat layer, a charge generation layer, and a charge transport layer. The hardened material is included in the charge transport layer. In this case, the thickness of the charge transport layer is uncontrollable because it depends on the hardening conditions. Therefore, it is preferable that the cross-linked charge transport layer is further provided above the charge transport layer and the hardened material is included in the cross-linked charge transport layer.

The cross-linked charge transport layer including the hardened material preferably has a thickness of 3 μm or more. When forming too thin a cross-linked charge transport layer, components in the lower layer may be undesirably immixed and spread therein, resulting in inhibition of hardening reaction or deterioration of the cross-linking density. The cross-linked charge transport layer having a thickness of 3 μm or more is a high-density cross-linked body that prevents production of white spots in the resulting image. Additionally, the cross-linked charge transport layer having a thickness of 3 μm is so durable that the occurrence of local variation in chargeability or sensitivity is prevented, resulting in a long lifespan.

The charge generation layer includes a charge generation material and optional materials such as a binder resin. Usable charge generation materials include both inorganic and organic materials.

Specific examples of usable inorganic charge generation materials include, but are not limited to, crystalline selenium, amorphous selenium, selenium-tellurium, selenium-tellurium-halogen, selenium-arsenic, and amorphous silicon. Preferably, in amorphous silicon, dangling bonds are terminated with hydrogen or halogen atom or doped with boron or phosphorous atom.

Specific examples of suitable organic charge generation materials include, but are not limited to, phthalocyanine pigments (e.g., metal phthalocyanine, metal-free phthalocyanine), azulenium pigments, squaric acid methine pigments, azo pigments having a carbazole skeleton, azo pigments having a triphenylamine skeleton, azo pigments having a diphenylamine skeleton, azo pigments having an amine skeleton, azo pigments having a dibenzothiophene skeleton, azo pigments having a fluorenone skeleton, azo pigments having an oxadiazole skeleton, azo pigments having a bisstilbene skeleton, azo pigments having a distyryl oxadiazole skeleton, azo pigments having a distyryl carbazole skeleton, perylene pigments, anthraquinone and polycyclic quinone pigments, quinone imine pigments, diphenylmethane and triphenylmethane pigments, benzoquinone and naphthoquinone pigments, cyanine and azomethine pigments, indigoid pigments, and bisbenzimidazole pigments. Two or more of these materials can be used in combination.

Specific examples of usable binder resins include, but are not limited to, polyamide resins, polyurethane resins, epoxy resins, polyketone resins, polycarbonate resins, silicone resins, acrylic resins, polyvinyl butyral resins, polyvinyl formal resins, polyvinyl ketone resins, polystyrene resins, poly-N-vinyl carbazole resins, and polyacrylamide resins. Two or more of these resins can be used in combination.

Additionally, charge transport polymers, such as (i) polymers (e.g., polycarbonate, polyester, polyurethane, polyether, polysiloxane, acrylic resin) having an arylamine, benzidine, hydrazone, carbazole, stilbene, or pyrazoline skeleton and (ii) polymers having a polysilane skeleton are also usable as the binder resin for the charge generation layer.

Specific examples of the above-described polymers of (i) include, but are not limited to, charge transport polymers described in JP-H01-001728-A, JP-H01-009964-A, JP-H01-013061-A, JP-H01-019049-A, JP-H01-241559-A, JP-H04-011627-A, JP-H04-175337-A, JP-H04-183719-A, JP-H04-225014-A, JP-H04-230767-A, JP-H04-320420-A, JP-H05-232727-A, JP-H05-310904-A, JP-H06-234836-A, JP-H06-234837-A, JP-H06-234838-A, JP-H06-234839-A, JP-H06-234840-A, JP-H06-234841-A, JP-H06-239049-A, JP-H06-236050-A, JP-H06-236051-A, JP-H06-295077-A, JP-H07-056374-A, JP-H08-176293-A, JP-H08-208820-A, JP-H08-211640-A, JP-H08-253568-A, JP-H08-269183-A, JP-H09-062019-A, JP-H09-043883-A, JP-H09-71642-A, JP-H09-87376-A, JP-H09-104746-A, JP-H09-110974-A, JP-H09-110976-A, JP-H09-157378-A, JP-H09-221544-A, JP-H09-227669-A, JP-H09-235367-A, JP-H09-241369-A, JP-H09-268226-A, JP-H09-272735-A, JP-H09-302084-A, JP-H09-302085-A, and JP-H09-328539-A.

Specific examples of the above-described polymers of (ii) include, but are not limited to, polysilylene polymers described in JP-S63-285552-A, JP-H05-19497-A, JP-H05-70595-A, and JP-H10-73944-A.

The charge generation layer may further include a low-molecular-weight charge transport material. Usable low-molecular-weight charge transport materials include both hole transport materials and electron transport materials.

Specific preferred examples of suitable electron transport materials include, but are not limited to, chloranil, bromanil, tetracyanoethylene, tetracyanoquinodimethane, 2,4,7-trinitro-9-fluorenon, 2,4,5,7-tetranitro-9-fluorenon, 2,4,5,7-tetranitroxanthone, 2,4,8-trinitrothioxanthone, 2,6,8-trinitro-4H-indeno[1,2-b]thiophene-4-one, 1,3,7-trinitrodibenzothiophene-5,5-dioxide, and diphenoquinone derivatives. Two or more of these materials can be used in combination.

Specific preferred examples of suitable hole transport materials include, but are not limited to, oxazole derivatives, oxadiazole derivatives, imidazole derivatives, monoarylamine derivatives, diarylamine derivatives, triarylamine derivatives, stilbene derivatives, α-phenylstilbene derivatives, benzidine derivatives, diarylmethane derivatives, triarylmethane derivatives, 9-styrylanthracene derivatives, pyrazoline derivatives, divinylbenzene derivatives, hydrazone derivatives, indene derivatives, butadiene derivatives, pyrene derivatives, bisstilbene derivatives, and enamine derivatives. Two or more of these materials can be used in combination.

The charge generation layer can be formed by a vacuum thin-film forming method or a casting method.

The vacuum thin-film forming method may be, for example, a vacuum deposition method, a glow discharge decomposition method, an ion plating method, a sputtering method, a reactive sputtering method, or a CVD method.

In the casting method, the inorganic or organic charge generation material and an optional binder resin are dispersed in a solvent (e.g., tetrahydrofuran, dioxane, dioxolane, toluene, dichloromethane, monochlorobenzene, dichloroethane, cyclohexane, cyclopentanone, anisole, xylene, methyl ethyl ketone, acetone, ethyl acetate, butyl acetate) using a ball mill, an attritor, a sand mill, or a bead mill, and the resulting dispersion is subjected to spray coating, bead coating, or ring coating. A leveling agent, such as dimethyl silicone oil and methyl phenyl silicone oil, may be further added to the dispersion.

The charge generation layer preferably has a thickness of from 0.01 to 5 μm, and more preferably from 0.05 to 2 μm.

The charge transport layer has functions of retaining charges and binding the retained charges with charges generated in the charge generation layer by light exposure. The charge transport layer needs to have a high electric resistance to retain charges, and a low dielectric constant and high charge mobility to achieve a high surface potential.

The charge transport layer includes a charge transport material, a binder resin, and optional materials.

Usable charge transport materials include hole transport materials, electron transport materials, and charge transport polymers, but are not limited thereto.

Specific preferred examples of suitable electron transport materials (i.e., electron-accepting materials) include, but are not limited to, chloranil, bromanil, tetracyanoethylene, tetracyanoquinodimethane, 2,4,7-trinitro-9-fluorenon, 2,4,5,7-tetranitro-9-fluorenon, 2,4,5,7-tetranitroxanthone, 2,4,8-trinitrothioxanthone, 2,6,8-trinitro-4H-indeno[1,2-b]thiophene-4-one, and 1,3,7-trinitrodibenzothiophene-5,5-dioxide. Two or more of these materials can be used in combination.

Specific preferred examples of suitable hole transport materials (i.e., electron-donating materials) include, but are not limited to, oxazole derivatives, oxadiazole derivatives, imidazole derivatives, triphenylamine derivatives, 9-(p-diethylamino styryl anthracene), 1,1-bis-(4-dibenzylaminophenyl) propane, styryl anthracene, styryl pyrazoline, phenyl hydrazone, α-phenylstilbene derivatives, triazole derivatives, triazole derivatives, phenazine derivatives, acridine derivatives, benzofuran derivatives, benzimidazole derivatives, and thiophene derivatives. Two or more of these materials can be used in combination.

Specific preferred examples of suitable charge transport polymers include, but are not limited to:
(a) polymers having a carbazole ring, such as poly-N-vinylcarbazole and compounds described in JP-S50-82056-A, JP-S54-9632-A, JP-S54-11737-A, JP-H04-175337-A, JP-H04-183719-A, JP-H06-234841-A;
(b) polymers having a hydrazone structure, such as compounds described in JP-S57-78402-A, JP-S61-20953-A, JP-S61-296358-A, JP-H01-134456-A, JP-H01-179164-A, JP-H03-180851-A, JP-H03-180852-A, JP-H03-50555-A, JP-H05-310904-A, and JP-H06-234840-A;
(c) polysilylene polymers, such as compounds described in JP-S63-285552-A, JP-H01-88461-A, JP-H04-264130-A, JP-H04-264131-A, JP-H04-264132-A, JP-H04-264133-A, and JP-H04-289867-A;
(d) polymers having a triarylamine structure, such as N,N-bis(4-methyphenyl)-4-aminopolystyrene and compounds described in JP-H01-134457-A, JP-H02-282264-A, JP-H02-304456-A, JP-H04-133065-A, JP-H04-133066-A, JP-H05-40350-A, and JP-H05-202135-A; and
(e) other polymers, such as formaldehyde condensation polymer of nitropyrene and compounds described in JP-S51-73888-A, JP-S56-150749-A, JP-H06-234836-A, and JP-H06-234837-A.

Additionally, specific preferred examples of suitable charge transport polymers further include, but are not limited to, polycarbonate resins having a triarylamine structure, polyurethane resins having a triarylamine structure, polyester resins having a triarylamine structure, polyether resins having a triarylamine structure, and compounds described in JP-S64-1728-A, JP-S64-13061-A, JP-S64-19049-A, JP-H04-11627-A, JP-H04-225014-A, JP-H04-230767-A, JP-H04-320420-A, JP-H05-232727-A, JP-H07-56374-A, JP-H09-127713-A, JP-H09-222740-A, JP-H09-265197-A, JP-H09-211877-A, and JP-H09-304956-A.

Additionally, polymers, copolymers, block copolymers, graft copolymers, star polymers, and cross-linked polymers disclosed in JP-H03-109406-A, all of which having an electron-donating group, are also usable.

Specific examples of usable binder resins include, but are not limited to, polycarbonate resins, polyester resins, methacrylic resins, acrylic resins, polyethylene resins, polyvinyl chloride resins, polyvinyl acetate resins, polystyrene resins, phenol resins, epoxy resins, polyurethane resins, polyvinylidene chloride resins, alkyd resins, silicone resins, polyvinyl carbazole resins, polyvinyl butyral resins, polyvinyl formal resins, polyacrylate resins, polyacrylamide resins, and phenoxy resins. Two or more of these resins can be used in combination.

The charge transport layer may also include a copolymer of a cross-linkable binder resin and a cross-linkable charge transport material.

The charge transport layer can be formed by dissolving or dispersing the charge transport material and the binder resin in a solvent, and coating and drying the resulting solution or dispersion. The charge transport layer may further include additives such as a plasticizer, an antioxidant, and a leveling agent.

Specific examples of usable solvents include, but are not limited to, tetrahydrofuran, dioxane, dioxolane, toluene, dichloromethane, monochlorobenzene, dichloroethane, cyclohexane, cyclopentanone, anisole, xylene, methyl ethyl ketone, acetone, ethyl acetate, and butyl acetate. In particular, solvents which dissolve the charge transport material and the binder resins are preferable. Two or more of the above solvents can be used in combination. The charge transport layer can be formed by a method similar to the above-described method of forming the charge generation layer.

Specific examples of usable plasticizers include, but are not limited to, dibutyl phthalate and dioctyl phthalate. The amount of plasticizer is preferably 0 to 3 parts by weight based on 100 parts by weight of the binder resin.

Specific examples of usable leveling agents include, but are not limited to, silicone oils (e.g., dimethyl silicone oil, methyl phenyl silicone oil), and polymers and oligomers having a side chain having a perfluoroalkyl group. The amount of leveling agent is preferably 0 to 1 parts by weight based on 100 parts by weight of the binder resin.

The charge transport layer preferably has a thickness of from 5 to 40 μm, and more preferably from 10 to 30 μm.

Suitable materials for the substrate include conductive materials having a volume resistivity of 10¹⁰ Ω·cm or less. Specific examples of such materials include, but are not limited to, plastic films, plastic cylinders, or paper sheets, on the surface of which a metal such as aluminum, nickel, chromium, nichrome, copper, gold, silver, platinum, and the like, or a metal oxide such as tin oxide, indium oxide, and the like, is formed by deposition or sputtering. In addition, a metal cylinder can also be used as the substrate, which is prepared by tubing a metal such as aluminum, aluminum alloy, nickel, and stainless steel by a method such as a drawing ironing method, an impact ironing method, an extruded ironing method, and an extruded drawing method, and then treating the surface of the tube by cutting, super finishing, polishing, and the like treatments. In addition, an endless nickel belt and an endless stainless steel belt disclosed in Examined Japanese Application Publication No. 52-36016, the disclosure thereof being incorporated herein by reference, can be also used as the substrate.

Further, substrates, in which a conductive layer is formed on the above-described substrates by applying a coating liquid including a binder resin and a conductive powder thereto, can be used as the substrate.

Specific examples of usable conductive powders include, but are not limited to, carbon black, acetylene black, powders of metals such as aluminum, nickel, iron, nichrome, copper, zinc, and silver, and powders of metal oxides such as conductive tin oxides and ITO. Specific examples of usable binder resins include thermoplastic, thermosetting, and photo-crosslinking resins, such as polystyrene resin, styrene-acrylonitrile copolymer, styrene-butadiene copolymer, styrene-maleic anhydride copolymer, polyester resin, polyvinyl chloride resin, vinyl chloride-vinyl acetate copolymer, polyvinyl acetate resin, polyvinylidene chloride resin, polyarylate resin, phenoxy resin, polycarbonate resin, cellulose acetate resin, ethyl cellulose resin, polyvinyl butyral resin, polyvinyl formal resin, polyvinyl toluene resin, poly-N-vinylcarbazole, acrylic resin, silicone resin, epoxy resin, melamine resin, urethane resin, phenol resin, and alkyd resin.

Such a conductive layer can be formed by coating a coating liquid in which a conductive powder and a binder resin are dispersed or dissolved in a proper solvent such as tetrahydrofuran, dichloromethane, methyl ethyl ketone, and toluene, and then drying the coated liquid.

In addition, substrates, in which a conductive layer is formed on a surface of a cylindrical substrate using a heat-shrinkable tube comprised of a resin such as polyvinyl chloride, polypropylene, polyester, polystyrene, polyvinylidene chloride, polyethylene, chlorinated rubber, and TEFLON®, which disperses a conductive powder therein, can also be used as the substrate.

The electrophotographic photoconductor may further include an intermediate layer between the charge transport layer and the cross-linked charge transport layer so as to prevent mixing of the charge transport layer with the cross-linked charge transport layer and to improve adhesiveness therebetween.

The intermediate layer is preferably insoluble or poorly-soluble in the cross-linked charge transport layer coating liquid. The intermediate layer is primarily comprised on a binder resin. Specific examples of usable binder resins include, but are not limited to, polyamide, alcohol-soluble nylon, water-soluble polyvinyl butyral, polyvinyl butyral, and polyvinyl alcohol. The intermediate layer can be formed by a method similar to the above-described method of forming the charge generation or transport layer. The intermediate layer preferably has a thickness of from 0.05 to 2 μm.

The electrophotographic photoconductor may further include an undercoat layer between the substrate and a photosensitive layer (e.g., the charge generation layer, the charge transport layer). The undercoat layer is primarily comprised of a resin having high solvent resistance because the photosensitive layer is formed thereon using a solvent. Specific preferred examples of such resins include, but are not limited to, water-soluble resins (e.g., polyvinyl alcohol, casein, sodium polyacrylate), alcohol-soluble resins (e.g., copolymerized nylon, methoxymethylated nylon), and three-dimensionally-networked hardened resins (e.g., polyurethane, melamine resins, phenol resins, alkyd-melamine resins, epoxy resins). The undercoat layer may further include powders of metal oxides (e.g., titanium oxide, silica, alumina, zirconium oxide, tin oxide, indium oxide) so as to prevent moire and residual potential decrease. Furthermore, Al₂O₃ prepared by anodic oxidization; and thin films of organic materials such as polyparaxylylene(parylene) and inorganic materials such as SiO₂, SnO₂, TiO₂, ITO, and CeO₂ prepared by a vacuum method may also be used as the undercoat layer.

The undercoat layer can be formed by a method similar to the above-described method of forming the charge generation or transport layer. The undercoat layer can be also formed using a silane coupling agent, a titan coupling agent, or a chrome coupling agent. The undercoat layer preferably has a thickness of from 0 to 5 μm.

Each of the cross-linked charge transport layer, charge transport layer, charge generation layer, undercoat layer, and intermediate layer may include an antioxidant for the purpose of improving environmental resistance and preventing deterioration in sensitivity and residual potential increase.

Specific preferred materials for the antioxidant include, but are not limited to, phenol compounds, p-phenylene diamines, hydroquinones, organic sulfur compounds, and organic phosphor compounds. Two or more of these materials can be used in combination.

Specific examples of the phenol compounds include, but are not limited to, 2,6-di-t-butyl-p-cresol, butylated hydroxyanisole, 2,6-di-t-butyl-4-ethylphenol, stearyl-β-(3,5-di-t-butyl-4-hydroxyphenyl)propionate, 2,2′-methylene-bis-(4-methyl-6-t-butylphenol), 2,2′-methylene-bis-(4-ethyl-6-t-butylphenol), 4,4′-thiobis-(3-methyl-6-t-butylphenol), 4,4′-butylidenebis-(3-methyl-6-t-butylphenol), 1,1,3-tris-(2-methyl-4-hydroxy-5-t-butylphenyl)butane, 1,3,5-trimethyl-2,4,6-tris(3,5-di-t-butyl-4-hydroxybenzyl)benzene, tetrakis-[methylene-3-(3′,5′-di-t-butyl-4′-hydroxyphenyl)propionate]methane, bis[3,3′-bis(4′-hydroxy-3′-t-butylphenyl)butyric acid]glycol ester, and tocopherols.

Specific examples of the p-phenylene diamines include, but are not limited to, N-phenyl-N′-isopropyl-p-phenylenediamine, N,N′-di-sec-butyl-p-phenylenediamine, N-phenyl-N-sec-butyl-p-phenylenediamine, N,N′-di-isopropyl-p-phenylenediamine, and N,N′-dimethyl-N,N′-di-t-butyl-p-phenylenediamine.

Specific examples of the hydroquinones include, but are not limited to, 2,5-di-t-octylhydroquinone, 2,6-didodecylhydroquinone, 2-dodecylhydroquinone, 2-dodecyl-5-chlorohydroquinone, 2-t-octyl-5-methylhydroquinone, and 2-(2-octadecenyl)-5-methylhydroquinone.

Specific examples of the organic sulfur compounds include, but are not limited to, dilauryl-3,3′-thiodipropionate, distearyl-3,3′-thiodipropionate, and ditetradecyl-3,3′-thiodipropionate.

Specific examples of the organic phosphor compounds include, but are not limited to, triphenylphosphine, tri(nonylphenyl)phosphine, tri(dinonylphenyl)phosphine, tricresylphosphine, and tri(2,4-dibutylohenoxy)phosphine.

The above-described compounds are generally known as antioxidants for rubbers, plastics, fats, and oils, and are commercially available.

The amount of the antioxidant is preferably from 0.01 to 10% by weight based on total weight of the layer.

Exemplary embodiments of the present invention are described in detail below with reference to accompanying drawings. In describing exemplary embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

FIG. 16 is a schematic view illustrating an image forming apparatus according to exemplary aspects of the invention.

A photoconductor 1 includes at least a photosensitive layer. The photoconductor 1 may have a drum-like shape as illustrated in FIG. 16 or alternatively, a sheet-like shape or an endless-belt-like shape. Each of a charger 3, a pre-transfer charger 7, a transfer charger 10, a separation charger 11, and a pre-cleaning charger 13, may be a corotron, a scorotron, a solid state charger, or a charging roller, for example.

In FIG. 16, the transfer charger 10 and the separation charger 11 constitute a transfer device. Alternatively, the transfer device may consist of one of the chargers described above.

Suitable light sources for an irradiator 5 and a decharging lamp 2 include illuminants such as a fluorescent lamp, a tungsten lamp, a halogen lamp, a mercury lamp, a sodium lamp, a light-emitting diode (LED), a laser diode (LD), and an electroluminescence (EL). In order to obtain light having a desired wavelength range, filters such as a sharp-cut filter, a band pass filter, a near-infrared cutting filter, a dichroic filter, an interference filter, and a color temperature converting filter, can be used.

The photoconductor 1 is exposed to light emitted from the irradiator 5 and the decharging lamp 2. The photoconductor 1 may be also exposed to light in the transfer process, the decharging process, the cleaning process, and/or an optional pre-irradiation process, if needed.

A developing unit 6 forms a toner image on the photoconductor 1, and the toner image is transferred onto a transfer paper 9. Some toner particles may remain on the photoconductor 1 without being transferred onto the transfer paper 9. Such residual toner particles are removed with a cleaning brush 14 and a blade 15. Alternatively, the residual toner particles may be removed with only the cleaning brush 14. The cleaning brush 14 may be a fur brush or a magnet fur brush, for example.

Generally, when the photoconductor 1 is positively (negatively) charged and exposed to light, a positive (negative) electrostatic latent image is formed thereon. When the positive (negative) electrostatic latent image is developed with a negatively (positively) chargeable toner, a positive image is produced. By contrast, when the positive (negative) electrostatic latent image is developed with a positively (negatively) chargeable toner, a negative image is produced.

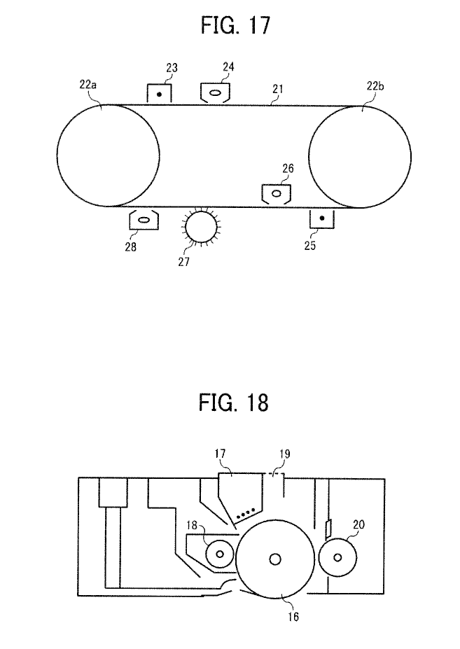

FIG. 17 is a schematic view illustrating another image forming apparatus according to exemplary aspects of the invention.

A photoconductor 21 includes a photosensitive layer. The photoconductor 21 is driven by driving rollers 22a and 22b, charged by a charger 23, and irradiated with a light beam emitted from an image irradiator 24. A toner image is formed on the photoconductor 21 by a developing device, not shown, and then transferred onto a transfer paper, not shown, by a transfer charger 25. The photoconductor 21 is then irradiated with a light beam emitted from a pre-cleaning irradiator 26, cleaned by a brush 27, and decharged by a decharging irradiator 28. The above-described operation is repeatedly performed. As illustrated in FIG. 17, the pre-cleaning irradiator 26 irradiates the photoconductor 21 from a side on which the substrate is provided, in a case in which the substrate is translucent.

Alternatively, the pre-cleaning irradiator 26 may irradiate the photoconductor 21 from a side on which the photosensitive layer is provided. Each of the image irradiator 24 and the decharging irradiator 28 may irradiate the photoconductor 21 from a side on which a substrate is provided.

Further, an optional pre-transfer irradiator and an optional pre-irradiator may also be provided.

Each of the above-described image forming members and devices may be fixedly mounted on image forming apparatuses such as a copier, a facsimile machine, and a printer. Alternatively, each of the image forming members and devices may be integrally combined as a process cartridge. An exemplary process cartridge includes a photoconductor, a charger, an irradiator, a developing device, a transfer device, a cleaning device, and a decharging device. FIG. 18 is a schematic view illustrating a process cartridge according to exemplary aspects of the invention. The process cartridge illustrated in FIG. 18 includes a photoconductor 16 according to this specification, a charger 17, a cleaning brush 18, an image irradiator 19, and a developing roller 20. The photoconductor 16 comprises a conductive substrate and a photosensitive layer formed on the conductive substrate.

Another embodiment of the image forming apparatus may include the electrophotographic photoconductor and the process cartridge described above, which is detachable from the image forming apparatus. Another embodiment of the process cartridge may include the electrophotographic photoconductor and at least one of the charger, image irradiator, developing unit, transfer unit, and cleaner. Such a process cartridge may be detachably mountable on an image forming apparatus along a rail guide.

The image forming method, image forming apparatus, and process cartridge according exemplary aspects of the invention includes the above-described multilayer electrophotographic photoconductor having a cross-linked charge transport layer, having high resistance to abrasion, scratch, crack, and peeling off. Such a photoconductor is applicable not only to electrophotographic copiers but also to electrophotographic application fields, such as laser beam printers, CRT printers, LED printers, liquid crystal printers, and laser plate makings.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Compounds No. 12 to 20 shown in Table 3 were used in the following Examples and Comparative Examples.

TABLE 3

| Compound | |
|---|---|
| No. | Chemical Formula |
| 12 | 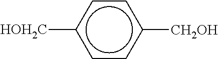 |
| 13 | 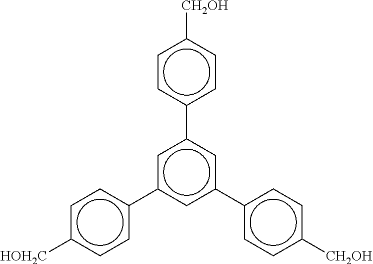 |
| 14 | 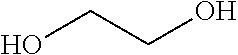 |
| 15 | 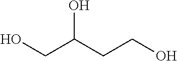 |
| 16 | 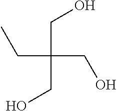 |
| 17 | 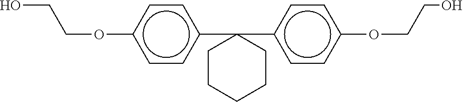 |
| 18 | 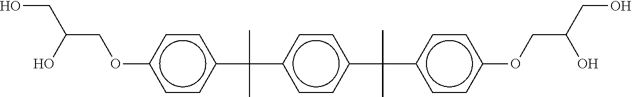 |
| 19 | 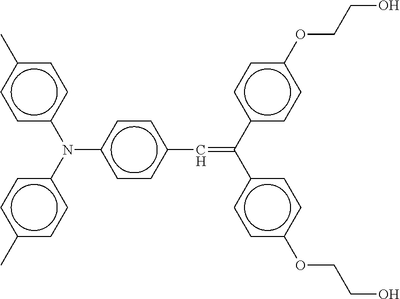 |
| 20 | 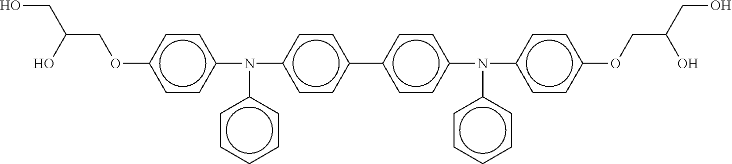 |

### Example 1

An aluminum cylinder having a diameter of 30 mm was coated with an undercoat layer coating liquid including 6 parts of an alkyd resin (BECKOSOL 1307-60-EL from DIC Corporation), 4 parts of a melamine resin (SUPER BECKAMINE G-821-60 from DIC Corporation), 40 parts of titanium oxide, and 50 parts of methyl ethyl ketone, and dried to form an undercoat layer having a thickness of 3.5 μm.

The undercoat layer was coated with a charge generation layer coating liquid including 0.5 parts of a polyvinyl butyral (XYHL from Union Carbide Corporation), 200 parts of cyclohexanone, 80 parts of methyl ethyl ketone, and 12 parts of a bisazo pigment having the following formula:

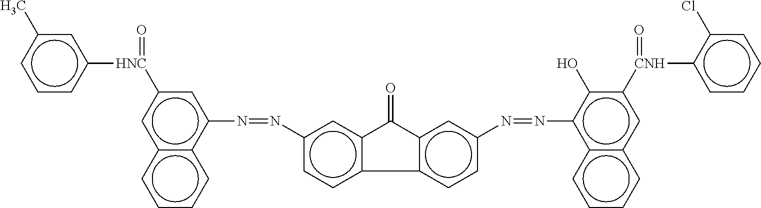

and dried to form a charge generation layer having a thickness of 0.2 μm.

The charge generation layer was coated with a charge transport layer coating liquid including 10 parts of a bisphenol Z polycarbonate (PANLITE TS-2050 from Teijin Chemicals Ltd.), 100 parts of tetrahydrofuran, 0.2 parts of a 1% tetrahydrofuran solution of silicone oil (KF50-100CS from Shin-Etsu Chemical Co., Ltd.), and 7 parts of a low-molecular-weight charge transport material having the following formula:

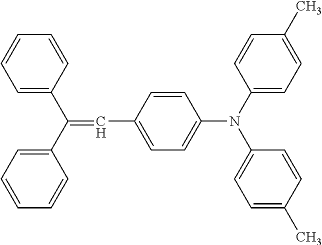

and dried to form a charge transport layer having a thickness of 18 μm.

The charge transport layer was spray-coated with a cross-linked charge transport layer coating liquid including 10 parts of the compound No. 1 (as the compound A), 10 parts of the compound No. 15 (as the compound B), 0.02 parts of p-toluene sulfonic acid, and 100 parts of tetrahydrofuran, and dried for 30 minutes at 135° C. to form a cross-linked charge transport layer having a thickness of 5.0 μm.

Thus, a photoconductor 1 was prepared.

### Example 2

The procedure in Example 1 was repeated except that the compounds No. 1 and No. 15 were replaced with the compounds No. 3 and No. 16, respectively. Thus, a photoconductor 2 was prepared.

### Example 3

The procedure in Example 1 was repeated except that the compounds No. 1 and No. 15 were replaced with the compounds No. 5 and No. 14, respectively. Thus, a photoconductor 3 was prepared.

### Example 4

The procedure in Example 1 was repeated except that the compound No. 1 was replaced with the compound No. 5. Thus, a photoconductor 4 was prepared.

### Example 5

The procedure in Example 1 was repeated except that the compounds No. 1 and No. 15 were replaced with the compounds No. 5 and No. 17, respectively. Thus, a photoconductor 5 was prepared.

### Example 6

The procedure in Example 1 was repeated except that the compounds No. 1 and No. 15 were replaced with the compounds No. 5 and No. 18, respectively. Thus, a photoconductor 6 was prepared.

### Example 7

The procedure in Example 1 was repeated except that the compounds No. 1 and No. 15 were replaced with the compounds No. 5 and No. 19, respectively. Thus, a photoconductor 7 was prepared.

### Example 8

The procedure in Example 1 was repeated except that the compounds No. 1 and No. 15 were replaced with the compounds No. 5 and No. 1, respectively. Thus, a photoconductor 8 was prepared.

### Example 9

The procedure in Example 1 was repeated except that the compound No. 1 was replaced with the compound No. 6. Thus, a photoconductor 9 was prepared.

### Example 10

The procedure in Example 1 was repeated except that the compounds No. 1 and No. 15 were replaced with the compounds No. 5 and No. 6, respectively. Thus, a photoconductor 10 was prepared.

### Example 11

The procedure in Example 1 was repeated except that the compounds No. 1 and No. 15 were replaced with the compounds No. 12 and No. 20, respectively, and the amount of the p-toluene sulfonic acid was changed to 1 part. Thus, a photoconductor 11 was prepared.

### Example 12

The procedure in Example 1 was repeated except that the compounds No. 1 and No. 15 were replaced with the compounds No. 13 and No. 19, respectively, and the amount of the p-toluene sulfonic acid was changed to 1 part. Thus, a photoconductor 12 was prepared.

### Example 13

The procedure in Example 1 was repeated except that the compounds No. 1 and No. 15 were replaced with the compounds No. 7 and No. 16, respectively. Thus, a photoconductor 13 was prepared.

### Example 14

The procedure in Example 1 was repeated except that the compounds No. 1 and No. 15 were replaced with the compounds No. 9 and No. 17, respectively. Thus, a photoconductor 14 was prepared.

### Example 15

The procedure in Example 1 was repeated except that the compounds No. 1 and No. 15 were replaced with the compounds No. 8 and No. 18, respectively. Thus, a photoconductor 15 was prepared.

### Example 16

The procedure in Example 1 was repeated except that the compounds No. 1 and No. 15 were replaced with the compounds No. 6 and No. 4, respectively. Thus, a photoconductor 16 was prepared.

### Example 17

The procedure in Example 1 was repeated except that the compounds No. 1 and No. 15 were replaced with the compound No. 5 and a polyvinyl butyral (XYHL from Union Carbide Corporation), respectively. Thus, a photoconductor 17 was prepared.

### Comparative Example 1

The procedure in Example 1 was repeated except that the compound No. 1 was replaced with the compound No. 19. Thus, a comparative photoconductor 1 was prepared.

### Comparative Example 2

The procedure in Example 1 was repeated except that the compound No. 1 was replaced with the following compound (C). Thus, a comparative photoconductor 2 was prepared.

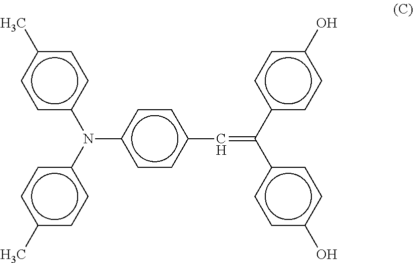

### Comparative Example 3

The procedure in Example 1 was repeated except that the compound No. 1 was replaced with the following compound (D). Thus, a comparative photoconductor 3 was prepared.

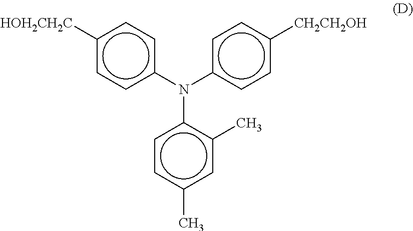

### Comparative Example 4

The procedure in Example 1 was repeated except that the compound No. 15 was replaced with the compound No. 14. Thus, a comparative photoconductor 4 was prepared.

### Comparative Example 5

The procedure in Example 1 was repeated except that the compounds No. 1 and No. 15 were replaced with the compound No. 5 and a resol resin (PL-4852 from Gunei Chemical Industry Co., Ltd.), respectively, and the tetrahydrofuran was replaced with isopropyl alcohol. However, a reliable layer cannot be formed in this case due to the occurrence of repelling of the coating liquid.

### Measurement of Rate of Gel in Cross-linked Charge Transport Layer

An aluminum substrate was coated with each of the cross-linked charge transport layer coating liquid prepared in Examples 1 to 17 and Comparative Examples 1 to 4 (except for Comparative Example 5) and dried by heat. The resulting layer was dipped in tetrahydrofuran for 5 days at 25° C., and the rate of gel was determined from the following equation:

Rate of gel (%)=100×(W2/W1)

wherein W1 represents the initial weight of the cross-linked charge transport layer and W2 represents the weight of the cross-linked charge transport layer after dipped in tetrahydrofuran for 5 days at 25° C.

The results are shown in Table 4.

TABLE 4

| | | | Rate of |
|---|---|---|---|
| | Compound A | Compound B | Gel (%) |
| Example 1 | No. 1 | No. 15 | 90 |
| Example 2 | No. 3 | No. 16 | 89 |
| Example 3 | No. 5 | No. 14 | 91 |
| Example 4 | No. 5 | No. 15 | 98 |
| Example 5 | No. 5 | No. 17 | 92 |
| Example 6 | No. 5 | No. 18 | 99 |
| Example 7 | No. 5 | No. 19 | 91 |
| Example 8 | No. 5 | No. 1 | 95 |
| Example 9 | No. 6 | No. 15 | 98 |
| Example 10 | No. 5 | No. 6 | 99 |
| Example 11 | No. 12 | No. 20 | 95 |
| Example 12 | No. 13 | No. 19 | 90 |
| Example 13 | No. 7 | No. 16 | 98 |
| Example 14 | No. 9 | No. 17 | 92 |
| Example 15 | No. 8 | No. 18 | 99 |
| Example 16 | No. 6 | No. 4 | 99 |
| Example 17 | No. 5 | Polyvinyl butyral | 91 |
| Comparative Example 1 | No. 19 | No. 15 | 0 |
| Comparative Example 2 | (C) | No. 15 | 72 |
| Comparative Example 3 | (D) | No. 15 | 0 |
| Comparative Example 4 | No. 1 | No. 14 | 12 |

### Running Test

Each of the photoconductors prepared in Examples 1 to 17 and Comparative Examples 1 to 4 (except for Comparative Example 5) was subjected to a running test in which an image is continuously produced on 100,000 sheets of A4-size paper using a toner including an external additive of silica and having a volume average particle diameter of 9.5 μm and an average circularity of 0.91.

Specifically, each of the photoconductor was mounted on a process cartridge for use in a modified image forming apparatus IMAGIO NEO 270 (from Ricoh Co., Ltd.) in which the image irradiating light source was a semiconductive laser having a wavelength of 655 nm and the dark section potential was set to 900 (−V). The initial and 100,000^{th} images were subjected to evaluation of image quality, and the bright section potential of a portion where the light quantity for image irradiation was about 0.4 μJ/cm² is measured after the initial and 100,000^{th} images were produced. Abrasion depth was determined from the difference in layer thickness before and after the running test. The 100,000^{th} image was visually observed to count the number of white spots in solid image portions. The results are shown in Table 5.

TABLE 5

| | | | After printing | | | Num- |
|---|---|---|---|---|---|---|
| | Initial stage | | 100,000 sheets | | | ber of |
| | Bright | | Bright | | | White |
| | Section | | Section | | | Spots |
| | Poten- | | Poten- | | Abrasion | (per |
| | tial | Image | tial | Image | Depth | 100 |
| | (−V) | Quality | (−V) | Quality | (μm) | cm²) |
| Example 1 | 27 | Good | 39 | Good | 2.1 | 10-15 |
| Example 2 | 25 | Good | 35 | Good | 2.9 | 10-15 |
| Example 3 | 65 | Good | 95 | Good | 2.2 | 10-15 |
| Example 4 | 35 | Good | 45 | Good | 0.8 | 0-5 |
| Example 5 | 52 | Good | 85 | Good | 2.7 | 10-15 |
| Example 6 | 57 | Good | 98 | Good | 0.7 | 0-5 |
| Example 7 | 40 | Good | 53 | Good | 1.2 | 10-15 |
| Example 8 | 39 | Good | 46 | Good | 1.0 | 0-5 |
| Example 9 | 30 | Good | 35 | Good | 0.9 | 0-5 |
| Example 10 | 40 | Good | 60 | Good | 0.5 | 0-5 |
| Example 11 | 95 | Good | 146 | Image | 3.2 | 0-5 |
| | | | | density | | |
| | | | | decreased | | |
| Example 12 | 98 | Good | 194 | Image | 4.1 | 10-15 |
| | | | | density | | |
| | | | | decreased | | |
| Example 13 | 37 | Good | 55 | Good | 1.0 | 0-5 |
| Example 14 | 56 | Good | 84 | Good | 1.9 | 10-15 |
| Example 15 | 48 | Good | 86 | Good | 1.0 | 0-5 |
| Example 16 | 37 | Good | 45 | Good | 1.3 | 0-5 |
| Example 17 | 85 | Good | 162 | Image | 2.5 | 10-15 |
| | | | | density | | |
| | | | | decreased | | |
| Compar- | 65 | Good | 135 | Image | 15.0 | 0-5 |
| ative | | | | density | | |
| Example 1 | | | | decreased | | |
| Compar- | 84 | Good | 312 | Image | 7.0 | >100 |
| ative | | | | density | | |
| Example 2 | | | | consider- | | |
| | | | | ably | | |
| | | | | decreased | | |
| Compar- | 62 | Good | 154 | Image | 14.0 | 0-5 |
| ative | | | | density | | |
| Example 3 | | | | decreased | | |
| Compar- | 45 | Good | 56 | Good | 12.0 | 0-5 |
| ative | | | | | | |
| Example 4 | | | | | | |

Table 5 shows that the photoconductors of Examples 1 to 17 have excellent abrasion resistance and produce defective image only slightly. The number of white spots observed in Examples 1 to 17 is relatively small. This is because silica does not get stuck in the surface of the photoconductor. Accordingly, the photoconductors of Examples 1 to 17 can reliably form high quality image for an extended period of time.

In particular, the photoconductor including the hardened material including gel in an amount of 95% or more does not produce defective image. Moreover, the photoconductor including the hardened material including gel in an amount of 97% or more has better abrasion resistance and does not produce defective image.

Additional modifications and variations of the present invention are possible in light of the above teachings. It is therefore to be understood that within the scope of the appended claims the invention may be practiced other than as specifically described herein.

What is claimed is:

1. An electrophotographic photoconductor, comprising:
a layer comprising a cross-linked hardened material of a compound A with a compound B,
the compound A having X methylol groups, X being an integer of 2 or more,
the compound B having Y alcohol groups, Y being an integer of 2 or more, and
at least one of the compounds A and B having a charge transportable group,
wherein the following relations are satisfied:
x=2 and y≧3, or
x≧3 and y≧2.

2. The electrophotographic photoconductor according to claim 1, wherein the compound A has the following formula (1): 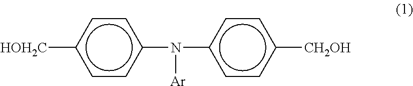
wherein Ar represents an aryl group which may have a substituent.

3. The electrophotographic photoconductor according to claim 1, wherein the compound A is N,N,N-trimethylol triphenylamine having the following formula (2):

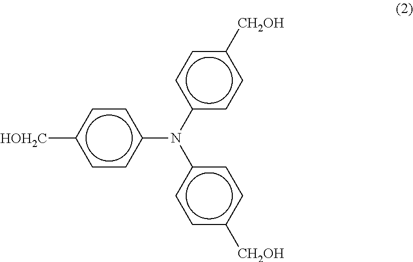

4. The electrophotographic photoconductor according to claim 1, wherein the compound A has the following formula (3): 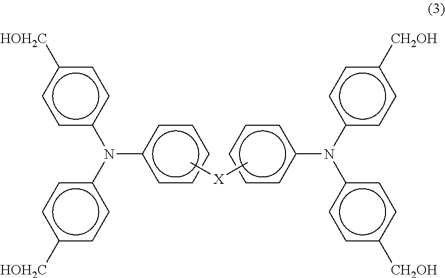
wherein X represents —O—, —CH₂—, —CH═CH—, or —CH₂CH₂—.

5. The electrophotographic photoconductor according to claim 1, wherein the layer comprising the cross-linked hardened material forms an outermost layer.

6. The electrophotographic photoconductor according to claim 5, further comprising a charge generation layer, a charge transport layer, and a cross-linked charge transport layer,
wherein the cross-linked charge transport layer forms the outermost layer.

7. An image forming method, comprising:
charging a surface of the electrophotographic photoconductor according to claim 1;
irradiating the charged surface of the electrophotographic photoconductor with light to form an electrostatic latent image thereon;
developing the electrostatic latent image into a toner image;
transferring the toner image from the electrophotographic photoconductor onto a recording medium; and
fixing the toner image on the recording medium.

8. The image forming method according to claim 7, wherein, in the irradiating, the electrostatic latent image is formed by a digital method.

9. An image forming apparatus, comprising:
the electrophotographic photoconductor according to claim 1;
a charger that charges a surface of the electrophotographic photoconductor;
an irradiator that irradiates the charged surface of the electrophotographic photoconductor with light to form an electrostatic latent image thereon;
a developing device that develops the electrostatic latent image into a toner image;
a transfer device that transfers the toner image from the electrophotographic photoconductor onto a recording medium; and
a fixing device that fixes the toner image on the recording medium.

10. The image forming apparatus according to claim 9, wherein the irradiator forms the electrostatic latent image by a digital method.

11. A process cartridge detachably mountable on image forming apparatus, comprising:
the electrophotographic photoconductor according to claim 1; and
at least one of a charger, an irradiator, a developing device, a cleaning device, and a decharging device.
